(19) United States
(12) Patent Application Publication
(10) Pub. No.: US 2004/0168597 A1
(43) Pub. Date: Sep. 2, 2004

(54) Printing process film, manufacturing method thereof, process film recycling method, and printer

(76) Inventors: Yasuharu Suda, Hiroshima-ken (JP); Toyoshi Ohto, Hiroshima-ken (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/480,252

(22) PCT Filed: Feb. 18, 2003
(86) PCT No.: PCT/JP03/01729

(30) Foreign Application Priority Data
Feb. 27, 2002 (JP) 2002-51647

(51) Int. Cl. B41N 1/00

(52) U.S. Cl. 101/453

(57) ABSTRACT

The present invention relates to a printing plate, a fabricating method thereof, a regenerating method of a printing plate and a printing press. A printing plate, on which an image is formed by light having a wavelength equal to or shorter than that of visible light and which is able to be made ready for printing without a wet development process and to be regenerated for reuse, includes: a substrate (1); a photosensitive layer (3), formed on a surface of said substrate (1) and including a photocatalyst that responds to light having a wavelength equal to or shorter than that of visible light; and an intermediate layer (2), interposed between said substrate (1) and said photosensitive layer (3) and including a semiconductor or an electric conductor.

### TECHNICAL FIELD

The present invention relates to a reusable printing plate, fabricating and regenerating methods thereof, and a printing plate.

### BACKGROUND OF THE INVENTION

In recent years, digitalization of printing processes has been progressing in the art. This technology involves creation of images and manuscripts in digitized form on a personal computer or reading images with a scanner and directly makes a printing plate ready for printing based on the digital data thus obtained. This makes it possible to save labor in the whole printing processes and also to conduct high-definition printing with ease.

So-called PS plates (presensitized plates) have been commonly used as printing plates to date. A PS plate includes a hydrophilic non-image area made of anodized aluminum and one or more hydrophobic image areas formed by curing a photosensitive resin on the surface of the anodized aluminum. Making a printing plate ready for printing with such a PS plate requires a number of steps and hence, is time-consuming and costly. It is therefore difficult to reduce the time and the cost required for a printing process. Especially in short-run printing, the requirement for such plural steps causes increased printing costs. Additionally, since use of a PS plate requires a development step using a developer, serious problems arise not only with the need for considerable amounts of labor but also with environmental pollution caused by treatment of developer waste in view of the prevention of environmental pollution.

Further, it is a common practice to expose a PS plate the surface of which is in contact with a film through which a desired image is perforated to light. This causes problems in making the printing plate ready for printing directly from digital data and in promoting a digitized printing process. Moreover, after completion of printing of a pattern, it has been necessary to replace the printing plate with another one in order to conduct printing of the next pattern, and used printing plates have been thrown away.

To solve the above-described problems of PS plates, methods have been proposed to meet the digitization of a printing process while making it possible to omit the development step, and some of such methods have come into commercial use. For example, Japanese Patent Application Laid-Open (KOKAI) Publication No. SHO 63-102936 discloses a process of making a plate ready for printing comprising the steps of: applying ink containing a photosensitive resin used as an ink for a liquid ink-jet printer to the surface of a printing plate; and curing an image area by irradiation with light. Japanese Patent Application Laid-Open (KOKAI) Publication No. HEI 11-254633, on the other hand, discloses a process for making a color offset printing plate ready for printing by an ink-jet head through which solid ink is jetted.

Also included in known methods are a process for making a printing plate ready for printing, which comprises the step of writing, with a laser beam, an image on a printing plate, which is made of a PET (polyethylene terephthalate) film on which a laser absorbing layer such as carbon black covered with a silicone resin layer is formed, to cause the laser absorbing layer to evolve heat, which ablates off the silicone resin layer; and another process for preparing a printing plate ready for printing comprising the step of coating a lipophilic laser absorbing layer on an aluminum plate, coating a hydrophilic layer on the laser absorbing layer, and then ablating off the hydrophilic layer with a laser beam as in the above-described process.

Another proposed method discloses a printing plate made of a hydrophilic polymer, which plate is made ready for printing by lipophilizing an irradiated portion subjected to image exposure.

Further, a method in which an image is written on a PS plate with a laser beam directly from digital data is disclosed and a so-called CTP (Computer to Plate) that is an imaging device utilizes a blue laser beam having a wavelength of 405 nm, or an imaging device including a micromirror and a UV lamp is available on the market.

Although these method can make a printing plate ready for printing directly from digital data, replacement of a printing plate after printing one pattern with a new printing plate is required for the next printing. Therefore, these methods do not improve on the point that a printing plate used for one printing process is discarded.

Regarding the above problem, there are some proposed techniques including regeneration of a printing plate. For example, Japanese Patent Application Laid-Open (KOKAI) Publication No. HEI 10-250027 refers to a latent image block copy making use of a titanium dioxide photocatalyst, a fabrication process of the latent image block, and a printing press having the latent image block. Japanese Patent Application Laid-Open (KOKAI) Publication No. HEI 11-147360 also discloses an offset printing process of a printing plate making use of a photocatalyst. Each of these disclosures forms an image using light, i.e., ultraviolet light, practically, to activate the photocatalyst and regenerates the printing plate by hydrophobization of the photocatalyst caused by a heat treatment. Further, Japanese Patent Application Laid-Open (KOKAI) Publication No. HEI 11-105234 discloses a method for making a printing plate ready for printing comprising the step of hydrophilizing a photocatalyst with activating light, i.e., ultraviolet light, and then forming an image area by a heat-mode recording.

As disclosed in the paper (pages 124-125) entitled “Study of Photo-Induced Hydrophilic Conversion on the TiO₂ Surface Involved by Structural Conformation”, (by Minabe et al.) distributed at the Fifth Symposium on “Recent Developments of Photocatalytic Reactions” of the Photo Functionalized Materials Society in 1998, Prof. Fujishima, Prof. Hashimoto, et al. of the Research Center for Advanced Science and Technology, The University of Tokyo, have confirmed that a titanium dioxide photocatalyst is hydrophilized by heat treatment. According to the description in the above paper, the processes disclosed in the above laid-open paten applications in which a heat treatment hydrophobizes a photocatalyst to regenerate a printing plate cannot be realized. As a result, a printing plate cannot be regerenated and made ready for printing by these processes.

Considering the above circumstances, the Inventors have developed a printing plate, on which an image can be rapidly formed by an imaging unit utilizing light having a wavelength equal to or shorter than that of visible light, and a printing plate which can be rapidly regenerated after printing for reuse, and methods for fabricating and regenerating of such a printing plate. One of the important issues in this development research is rapid hydrophilization of a plate surface performed when an image is formed on the plate surface and a formed image area is deleted for regeneration.

As to a hydrophilization technique, the paper (pages 44-45) entitled “Effects of TiO₂/WO₃ Thin Films on Hydrophilization properties” (by Irie, et al.) distributed at the Eighth Symposium on “Recent Developments of Photocatalytic Reactions” of the Photo Functionalized Materials Society in 2001 discloses a technique of sensitization of photocatalytic activity, especially photo-induced hydrophilization, by forming a thin film of TiO₂ (titanium dioxide) on a thin film made of WO₃ (tungsten trioxide). However, the disclosure by Irie, et al. does not refer to influence of a TiO₂/WO₃ thin film on decomposition of an organic compound nor application of a TiO₂/WO₃ thin film to a printing plate.

The foregoing problems in view, it is an object of the present invention to provide a printing plate regeneratable for reuse, on which an image can be rapidly formed in a printing process and which can be rapidly regenerated, a fabricating method thereof, a regeneration method of a printing plate, and a printing press.

### DISCLOSURE OF THE INVENTION

In order to solve the above problems, the present invention takes the following measures.

As a first generic feature, the present invention provides printing plate, on which an image is formed by light having a wavelength equal to or shorter than that of visible light and which is able to be made ready for printing without a wet development process and to be regenerated for reuse, comprising: a substrate; a photosensitive layer, formed on a surface of the substrate and including a photocatalyst that responds to light having a wavelength equal to or shorter than that of visible light; and an intermediate layer, interposed between the substrate and the photosensitive layer and including a semiconductor or an electric conductor.

A portion of surface of the printing plate is hydrophilized by being irradiated with light having a wavelength equal to or shorter than that of visible light because of an action caused by hydrophilization of the photocatalyst. The portion that has been converted to hydrophilic serves as a non-image area to which fountain solution preferentially adheres but on which hydrophobic ink is hardly deposited. On the other hand, a portion that has not been irradiated with light having a wavelength equal to or shorter than that of visible light is hydrophobic and serves as an image area to which hydrophobic ink preferentially adheres but on which fountain solution is hardly deposited.

The above-mentioned light having a wavelength equal to or shorter than that of visible light, and having energy effective to exhibit photocatalytic activity of the photocatalyst, used in the present invention is called activating light.

It is therefore possible to form an image by irradiating a surface of the photosensitive layer with activating light having a wavelength equal to or shorter than that of visible light which irradiation causes a reaction of the photosensitive layer.

Additionally, after completion of a printing process, the entire surface of the printing plate can be hydrophilized by being irradiated with light having a wavelength equal to or shorter than that of visible light.

If an organic compound is applied to the surface of the photosensitive layer, it is possible to oxidative decompose the organic compound.

In particular, since the intermediate layer, interposed between the substrate and the photosensitive layer, includes a semiconductor or an electric conductor, an image can be rapidly formed by the activating light because of a property of the semiconductor or the electric conductor so that a printing plate fabrication can be realized in a short time and light energy required for image formation can be reduced.

When the printing plate is to be regenerated, it is possible to lower irradiation energy of the activating light that is to be irradiated the plate surface in order to delete an image area.

As described above, time required for image formation and plate regeneration can be reduced so that time for print preparation can also be reduced.

Reuse of a printing plate can greatly reduce the amount of plate wastes discarded after printing operations, thereby reducing costs for printing plates.

The printing plate is made ready for printing directly from digital data so that a printing process can be digitized and can be accomplished in a shorter time.

The printing plate can be made ready for printing and regenerated while the printing plate keeps to be mounted on a printing press whereupon operationality is improved because of no requirement for plate replacement.

As a preferable feature, the substrate may have flexibility. The substrate can be wrapped around the curved surface of a plate cylinder to suitably function as a printing plate.

As another preferable feature, the intermediate layer may include tungsten oxide serving as a semiconductor whereupon a reaction on the plate surface is surely enhanced and time required to make the printing plate ready for printing and to regenerate the printing plate can be surely reduced.

As an additional preferable feature, when the image is to be formed on the printing plate, a property of a surface of the photosensitive layer may be converted from hydrophobic to hydrophilic by irradiation with the light having a wavelength equal to or shorter than that of visible light. Conversion of a property of the surface of the photosensitive layer from hydrophobic to hydrophilic, which conversion is caused by irradiation with the surface of the photosensitive layer with light having a wavelength equal to or shorter than that of visible light, forms an image, so that the image can be rapidly formed by using a property of the semiconductor or the electric conductor to enhance hydrophilization.

As a further preferable feature, when the printing plate is to be regenerated, a property of the surface of the photosensitive layer may be converted from hydrophilic to hydrophobic by irradiating a surface of the printing plate with energy flux, such as light, electricity and/or heat, or by applying a mechanical stimulus, such as friction, to the surface of the printing plate. As a result, it is possible to hydrophobize the plate surface that underwent a printing process and the printing plate can be restored to the initial state in making the printing plate ready for printing.

As a still further preferable feature, if an organic compound is applied to the surface of the photosensitive layer in order to regenerate the printing plate, the organic compound may interact with the photosensitive layer so that a property of the surface of the photosensitive layer is converted from hydrophilic to hydrophobic. Since application of the organic compound to the surface of the photosensitive layer conducts an interaction between the organic compound and the surface of the photosensitive layer so that a property of the photosensitive layer is converted from hydrophilic to hydrophobic when regenerating the printing plate, it is possible to hydrophobize the surface experienced a printing process to restore the printing plate to the initial state in making the printing plate ready for printing.

As a still further preferable feature, the photocatalyst may be a titanium oxide photocatalyst or a modified titanium oxide photocatalyst. Here, the modified titanium oxide photocatalyst is obtaind by doping or containing a metal or non-metal atom other than that included in a titanium oxide photocatalyst by nature, or by changing the stoichimetric ratio of a titanium dioxide photocatalyst in which the ratio of Ti (titanium atoms) and O (oxygen atoms) are included in a ratio of 1:2. With such a photocatalyst, conversion between hydrophobic and hydrophilic can be surely realized.

As a still further preferable feature, the light having wavelength equal to or shorter than that of visible light may have a wavelength equal to or shorter than 600 nm. Here, preferable visible light has a wavelength of 400-600 nm, more preferably having a wavelength 400-500 nm. Accordingly, light having a wavelength equal to or shorter than that of visible light preferably has a wavelength up to 600 nm, further preferably having a wavelength up to 500 nm. It is therefore possible to use wide variety of imaging units.

As a second generic feature, the present invention provides a method for fabricating a printing plate, on which an image is formed by light having a wavelength equal to or shorter than that of visible light and which is able to be made ready for printing without a wet development process and to be regenerated for reuse, comprising the steps of: forming an intermediate layer, including a semiconductor or an electric conductor, on a surface of a substrate; fixing the intermediate layer on the surface of the substrate; forming a photosensitive layer, including a photocatalyst that responds to light having a wavelength equal to or shorter than that of visible light, on a surface of the intermediate layer; and fixing the photosensitive layer on the surface of the intermediate layer so that a printing plate can be fabricated.

As a third generic feature, the present invention also provides a method for fabricating a printing plate, on which an image is formed by light having a wavelength equal to or shorter than that of visible light and which is able to be made ready for printing without a wet development process and to be regenerated for reuse, comprising the steps of: forming an intermediate layer, including a semiconductor or an electric conductor, on a surface of a substrate; forming a photosensitive layer, including a photocatalyst that responds to light having a wavelength equal to or shorter than that of visible light, on a surface of the intermediate layer; and fixing the photosensitive layer and the intermediate layer on the surface of the substrate.

Each layer formation step is realized by a sol-coating process or a sputtering process, for example, and each fixing step is carried out by drying or burning, for example, to fix a layer, so that a printing plate can be fabricated.

As a fourth generic feature, a method of the present invention for regenerating a printing plate described as above, comprising the steps of: after completion of a printing operation, removing an ink from a surface of the printing plate; and hydrophobizing a surface of the photosensitive layer and thereby the printing plate can be regenerated.

As a preferable feature, the method may further comprise the step of: between the step of ink removing and the step of hydrophobizing, irradiating the surface of the photosensitive layer with light having a wavelength equal to or shorter than that of visible light so that the surface of the photosensitive layer is hydrophilized in order to regenerate the printing plate.

As another preferable feature, the step of hydrophobizing may include one of steps of irradiating the surface of the photosensitive layer with energy flux, such as light, electricity and/or heat, applying a mechanical stimulus, such as friction, to the surface of the photosensitive layer, and applying an organic compound to the surface of the photosensitive layer so that the organic compound interacts with the surface of the photosensitive layer. With this step, the printing plate is hydrophobized.

As a fifth generic feature, a printing press comprising: a plate cylinder having a curved surface for supporting a printing plate described as above; an image forming unit for irradiating a surface of the photosensitive layer with the light having a wavelength equal to or shorter than that of visible light; and a hydrophobizing unit for hydrophobizing the surface of the photosensitive layer. With this structure, since it is possible to make a printing plate ready for printing and regenerate a printing plate, keeping the printing plate mounted on the printing press, printing processes can be continued without interruption by plate replacement.

As a preferable feature, the hydrophobizing unit may hydrophobize the surface of the photosensitive layer by one of irradiating the surface of the photosensitive layer with energy flux, such as light, electricity and/or heat, applying a mechanical stimulus, such as friction, to the surface of the photosensitive layer, and applying an organic compound to the surface of the photosensitive layer so that the organic compound interacts with the surface of the photosensitive layer. The printing plate can be hydrophobized by various manners and can be restored to the initial state.

As another preferable feature, a printing press may further comprise an image area deleting unit for irradiating the entire surface of the printing plate with light having a wavelength equal to or shorter than that of visible light in order to delete an image area. With the image area deleting unit, an image area formed on the plate surface can be deleted, so that the printing plate can be regenerated by ensuing hydrophibozation of the plate surface.

### BRIEF DESCRIPTION OF THE DRAWINGS

FIG. 1 is a diagram illustrating a sectional view of a printing plate according to an embodiment of the present invention the surface of which is in a hydrophobic state;

FIG. 2 is a diagram illustrating a sectional view of a printing plate of an embodiment the surface of which is in a hydrophilic state;

FIG. 3 is a diagram showing a cycle from image formation to regeneration of a printing plate of an embodiment;

FIG. 4 is a schematic diagram illustrating a perspective view of a printing plate of an embodiment;

FIG. 5 is a graph showing a relationship between time (procedural steps) and contact angles of water on a printing plate of an embodiment;

FIG. 6 is a schematic diagram showing a printing press that carries out printing and regeneration of a printing plate according to an embodiment of the present invention;

FIG. 7 is a flowchart showing a succession of procedural steps of making a printing plate ready for printing and regenerating of a printing plate of an embodiment; and

FIG. 8 is a flowchart showing a succession of procedural steps of fabricating a printing plate of an embodiment.

### BEST MODE FOR CARRYING OUT THE INVENTION

Hereinafter, an embodiment of the present invention will now be described with reference to the accompanying drawing.

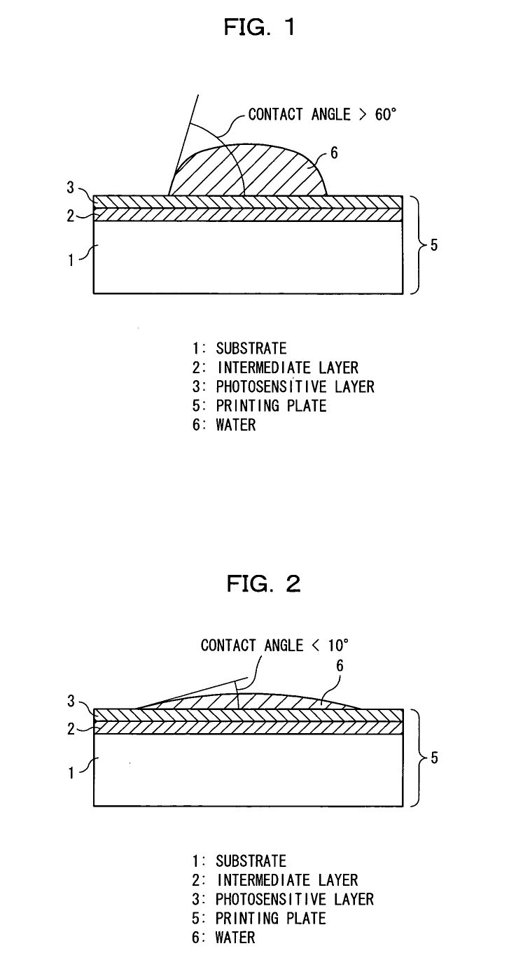

FIGS. 1 and 2 respectively illustrate a printing plate of an embodiment of the present invention: FIG. 1 shows a schematic sectional view of a plate surface exhibiting hydrophobicity; and FIG. 2 shows a schematic sectional view of a plate surface exhibiting hydrophilicity.

As shown in FIG. 1, the printing plate 5 basically comprises a substrate 1, an intermediate layer 2 and a photosensitive layer 3. A printing plate ready for printing represents a printing plate 5 on which an image area to be printed is formed.

The substrate 1 is made of metal, such as aluminum or stainless steel, or a polymer film. However, the material of the substrate 1 of the present invention should by no means be limited to metal of aluminum or stainless steel, or a polymer film.

A layer including a semiconductor or an electric conductor serves as an intermediate layer 2 formed on the substrate 1.

When a semiconductor is used, an oxide semiconductor such as zinc oxide ZnO, tin oxide SnO or tungsten oxide WO₃ is preferable. An intermediate layer 2 is preferably made of such a semiconductor on its own. Alternatively, a biding compound may grow fine particles of a semiconductor into a film, which is to be used as an intermediate layer 2.

When an electric conductor is used, an oxide such as ITO (an oxide of indium and tin), a metal such as aluminum, silver or copper, carbon black, or a conducting polymer can be used. An intermediate layer 2 is made of such an electric semiconductor by itself, or alternatively, a binding compound may grow fine particles of an electric conductor into a film, which is to serve as an intermediate layer 2.

An intermediate layer 2 that includes a semiconductor or an electric conductor speeds up image formation by light having a wavelength equal to or shorter than that of visible light, so that it is possible to shorten time required to make a printing plate for ready for printing, and reduces light energy required for image formation. Further, such an intermediate layer 2 can reduce an amount of light energy of activating light with which a printing plate is irradiated in order to delete an image area when regenerating the printing plate because it is assumed that the semiconductor or the electric conductor included in the intermediate layer 2 improves the function of a photocatalyst included in a photosensitive layer 3, which is to be described later.

A substrate 1 and an intermediate layer 2 may be interposed by a reinforcement layer (not shown) made of a silicone compound, such as silica (SiO₂), silicone resin or silicone rubber. Such a reinforcement layer ensures and improves rigid adhesion between the substrate 1 and the intermediate layer 2. In particular, silicone resin is exemplified by silicone alkyd, silicone urethane, silicone epoxy, silicone acrylic, silicone polyester. If adequate adhesive strength is ensured between the substrate 1 and the intermediate layer 2, the reinforcement layer may not be a necessity.

A photosensitive layer 3 including a titanium oxide photocatalyst, serving as a photocatalyst, is formed on the intermediate layer 2. Namely, the photosensitive layer 3 exhibits high catalytic activity by being irradiated with activating light having energy higher than the band gap energy of the photocatalyst.

As one of the features of the printing plate 5 of the illustrated embodiment, a photosensitive layer 3 is formed by a photocatalyst that responds to light having a wavelength equal to or shorter than 600 nm, a wavelength in the range of visible light (i.e., responds to at least one of visible light having a wavelength of 400-600 nm and ultraviolet light having wavelength equal to or shorter than 400 nm). The presence of such a photocatalyst makes the surface of a photosensitive layer 3 show high hydrophilicity when the photosensitive layer 3 is irradiated with activating light having a wavelength equal to or shorter than 600 nm. Further, if an organic compound is applied to the surface of the photosensitive layer 3, irradiation with such activating light oxidatively decomposes the applied organic compound because of the photocatalyst. The organic compound will be described in detail later.

A photocatalyst is not activated unless being irradiated with light having energy higher than the band-gap energy thereof. For example, since a titanium dioxide photocatalyst is originally as high as 3 eV in band-gap energy, the photocatalyst responds only to ultraviolet light having a wavelength up to 380 nm.

The present invention utilizes a photocatalyst that responds to activating light equal to or shorter than 600 nm, which light includes visible light having a longer wavelength than ultraviolet light, because of a new level set in the band gap of the photocatalyst. Although activating light having a wavelength up to 600 nm of course includes ultraviolet light, the photocatalyst responds to the activating light, including only visible light having wavelength of 400-600 nm but not including ultraviolet light, as well as to ultraviolet light.

Executing of methods that are already known produces a photocatalyst responsive to visible light. For example, Japanese Patent Application Laid-Open (KOKAI) Publication No. 2001-207082 discloses a visible-light-responsive photocatalyst obtained by doping nitrogen atoms; Japanese Patent Application Laid-Open (KOKAI) Publication No. 2001-205104, a visible-light-responsive photocatalyst obtained by doping chromium and nitrogen atoms; and further Japanese Patent Application Laid-Open (KOKAI) Publication No. HEI 11-197512, a visible-light-responsive photocatalyst obtained by ion implantation using metal ions, such as chromium ions. A visible-light-responsive photocatalyst is generated by another disclosed method in which cryogeneic plasma is utilized, and a visible-light-responsive photocatalyst containing platinum is also disclosed. The photocatalyst of so-called visible-light responsive type, which is obtained by execution of one of the above methods, is used to fabricate a printing plate 5 of the present embodiment.

In order to maintain the above properties and hydrophilicity and to improve adhesion between the substrate 1 and the photosensitive layer 3 and the strength of the photosensitive layer 3, a following substance may be added to the photosensitive layer 3 including a visible-light-responsive photocatalyst (here, the photosensitive layer sometimes called a photocatalyst layer because of the photocatalyst included therein). The substance is exemplified by silica compound such as silica, silica sol, organosilane, or a silicone resin, a metal oxide or a metal hydride such as hydride of zirconium, aluminum, titanium, or a fluorine resin.

The crystal structure of a base titanium dioxide photocatalyst is available in rutile, anatase and brucite. These structures are all usable in this embodiment, and they may be used in combination. In consideration of photocatalytic activity, the anatase structure is preferred.

As described below, a titanium oxide photocatalyst is preferably small in particle diameter in order to retain high photocatalytic activity to decompose an image area under irradiation with the activating light. Specifically, the particle diameter of a titanium dioxide photocatalyst is 0.1 μm or smaller, more preferably up to 0.05 μm. A preferable photocatalyst is a titanium oxide photocatalyst, but should by no means be limited to this.

The thickness of the photosensitive layer 3 is preferably in the range of 0.005 to 1 μm because an unduly small thickness makes it difficult to fully utilize the above-described properties while an excessively large thickness makes the photosensitive layer 3 susceptible to cracks and causes a reduction in print durability. As this cracking is pronouncedly observed when the thickness exceeds 10 μm, it is necessary to consider this 10 μm as the upper limit even if one tries to enlarge this range of thickness. In practice, this thickness may preferably be set in the range of 0.03 to 0.5 μm or so.

The photosensitive layer 3 is formed by a selected one of the sol coating processes, the organic titanate process, the sputtering process, the CVD method, the PVD method and other processes. If the sol coating process is adopted, for example, a sol coating formulation employed for use in the sol coating process may contain a solvent, a crosslinking agent, a surfactant and/or the like in addition to the titanium oxide photocatalyst and the above-described substances for improving the strength of the photosensitive layer 3 and its adhesion to the substrate 1.

The coating formulation may be either a room temperature drying type or a heat drying type, with the latter being more preferred because, in order to provide the resultant printing plate with improved print durability, it is advantageous to promote the strength of the photosensitive layer 3 by heating. It is also possible to form the photosensitive layer 3 of high strength, for example, by growing an amorphous titanium dioxide layer on a metal substrate by sputtering in a vacuum and then crystallizing the amorphous titanium dioxide by heat treatment or by another method.

A preferable organic compound that hydrophobizes the photosensitive layer 3 chemically reacts with or physically adheres to at least hydrophilic portion on the surface (plate surface) of the printing plate 5 to cover a surface in a hydrophilic state, thereby hydrophobizing the surface of the photosensitive layer 3, and at the same time, is easily decomposed by oxidative decomposition activity of the photocatalyst under irradiation with the activating light. A preferable example of an organic compound is an organic titanium compound, an organic silane compound, an isocyanate compound, or an epoxide compound. These compounds respectively react with a hydroxy group present at the surface of a photocatalyst in a hydrophilic state to be fixed to the surface, so that an organic compound monomolecular layer is formed on the surface of the photocatalyst in principle. Hydrophobizing the surface of a phtocatalyst by such a monomolecular layer decomposes the organic compound under irradiation with the activating light with ease.

The organic titanium compound is exemplified by (1) an alkoxy titanium, such as a tetra-1-propoxy titanium, a tetra-n-propoxy titanium, a tetra-n-butoxy titanium, a tetra-1-butoxy titanium or a tetrastearoxy titanium, (2) a titanium acylate, such as a tri-n-butoxy titanium stearate or an isopropoxy titanium tristearate, or (3) a titanium chelate, such as a diisopropoxy titanium bisacetylacetonate, a dihydroxy bislactato titanium or a titanium-1-propoxyoctylene glycol.

The organic silane compound is (1) an alokoxysilane exemplified by a trimethylmethoxysilane, a trimethylethoxysilane, a dimethyldiethoxysilane, a methyltrimethoxysilane, a tetramethoxysilane, a methyltriethoxysilane, a tetraethoxysilane, a methyldimethoxysilane, an octadecyltrimethoxysilane or an octadecyltriethoxysilane, (2) a chlorosilane, such as a trimethylchlorosilane, a dimethyldichlorosilane, a metyltrichlorosilane, a methyldichlorosilane or a dimethylchlorosilane, (3) a silane coupler, such as a vinyl-trichlorosilane, a vinyl-triethoxysilane, a γ-chloropropyltrimethoxysilane, a γ-chloropropyl methyldichlorosilane, a γ-chloropropyl methyldimethoxysilane, a γ-chloropropyl methyldiethoxysilane or γ-aminopropyltriethoxysilane, or (4) a pholoroalkylsilane exemplified by a perpholoroalkyltrimethoxysilane.

The isocyanate compound is an isocyanic dodecyl, an isocyanic octadecyle or the like.

The epoxide compound is exemplified by a 1,2-epoxydecane, a 1,2-epoxyhexadecane, a 1,2-epoxyoctadecane or the like.

The organic titanium compound, the organic silane compound, the isocyanate compound and the epoxide compound should by no means be limited to the above examples.

If the organic compound is liquid at room temperature, the organic compound is applied to the photosensitive layer 3 by blade coating, roll coating or dip coating, or the organic compound is formed into microdrops by a spray to be applied to the photosensitive layer 3. Alternatively, photocatalyst layer 3 may be coated with the organic compound in the form of gas obtained by heating the compound to a temperature below the decomposition temperature or in the form of vapor formed by a nebulizer utilizing ultrasound. Needless to say, the compound maybe resolved in another solution in order to adjust its concentration and viscosity.

Next, manners of making a printing plate ready for printing and regenerating the printing plate will now be described.

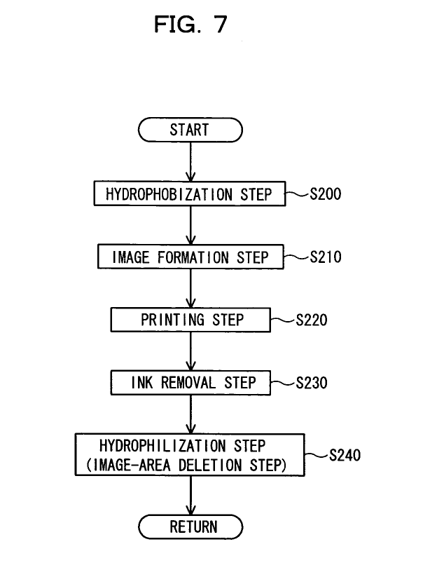

As shown in FIG. 7, a succession of procedural steps of making a printing plate ready for printing and referenating the printing plate includes a hydrophobization step (S200), an image formation step (S210), a printing step (S220), an ink removal step (S230) and a hydrophilization step (an image-area deletion step; S240).

First of all, description will be made in relation to making a printing plate ready for printing.

Hereinafter, “making the printing plate ready for printing” means writing of a hydrophilic non-image area by irradiating at least part of the surface of the printing plate 5 (i.e., the photosensitive layer 3), the surface of which has been hydrophobized (in the initial state), with light (activating light) having a wavelength up to that of visible light in accordance with digital data so that, together with one or more hydrophobic portions on the surface of the printing plate, which portions have not been irradiated with the activating light, a latent image including a hydrophobic image area and a hydrophilic non-image area is formed on the surface of the printing plate.

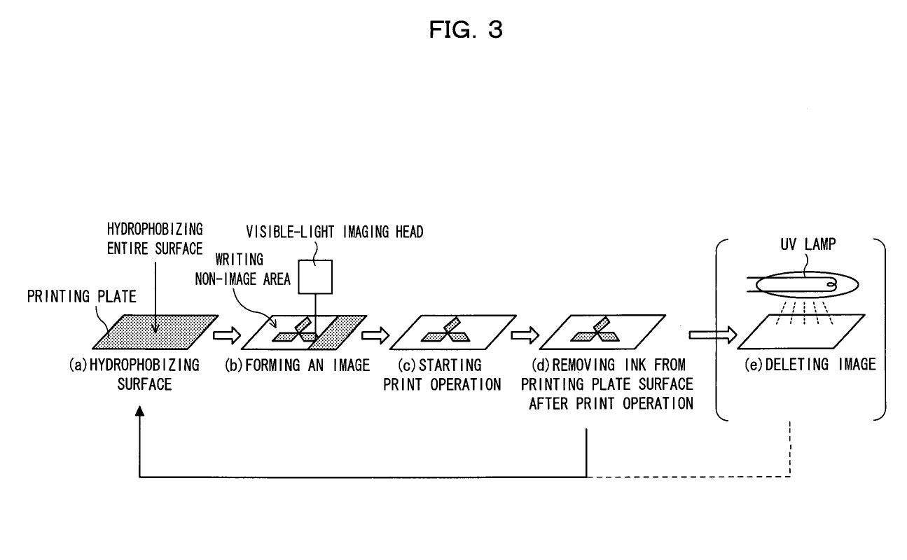

In a hydrophobization step (S200), the surface of the photosensitive layer 3, the entire surface of which has been hydrophilized in the prior step (a hydrophilization step (S240)), is hydrophobized. The step (a) in FIG. 3 illustrates the printing plate 5 in the initial state, in which the entire surface of the printing plate 5 is hydrophobized. Here, the hydrophobic surface of the printing plate 5 forms a contact angle with water thereon down to 50°, preferably down to 80°, which is in such a state that hydrophobic printing ink is held with ease but a fountain solution is hardly deposited.

This state of the photosensitive layer 3 is called the “initial state” in making the printing plate ready for printing. The “initial state” in making the printing plate ready for printing can be regarded as the start of an actual printing process (S220). Specifically, the initial state means a state in which an arbitrary image, the digital data of which has been already prepared, is about to be formed onto the printing plate 5.

In the ensuing step (S210) of image formation, a non-image area is written onto the surface of the photosensitive layer 3 in a hydrophobic state, as shown in FIG. 3(b).

Writing of the non-image area is performed conforming to digital image data so as to coincide with the data. This non-image area is in a hydrophilic state, as shown in FIG. 2, with a contact angle of water thereon equal to or smaller than 10°, in such a state that the fountain solution is held with ease but the printing ink is hardly deposited.

For an appearance of a hydrophilic non-image area in line with image data, light having a wavelength equal to or shorter than 600 nm, i.e., the activating light, is irradiated a portion of the surface of the photosensitive layer 3 and action of the photocatalyst hydrophilizes the irradiated portion. On the other hand, since a plate surface portion that has not been irradiated with the activated light remains in a hydrophobic state, a hydrophobic area and a hydrophilic area are formed on the plate surface whereupon the printing plate can be made ready for printing.

In the illustrated example, as shown at the step (b) in FIG. 3, an imaging head that utilizes visible light, such as a violet laser having a wavelength of 405 nm, writes an non-image area so that the non-image area is formed on the hydrophilic surface of the photosensitive layer 3.

In order to emerge a hydrophilic non-image area in line with image data, the above imaging head utilizing a violet laser having a wavelength of 405 nm is substituted by another imaging device that utilizes the activating light, such device being exemplified by an imaging head including light source toemitlighthaving a wavelength 360-450 nm and a micromirror, which head is incorporated in UV-setter™ 710 manufactured by basysprint GmbH (Germany).

Upon completion of the image formation step (S210), image and non-image areas have been formed on the surface of the photosensitive layer 3 as shown at step (c) of FIG. 3 and the printing plate is ready for being served for printing in the next printing step (S220).

In the printing step (S220), a so-called emulsion ink of a mixture of a hydrophobic printing ink and the fountain solution is applied to the surface of the printing plate 5.

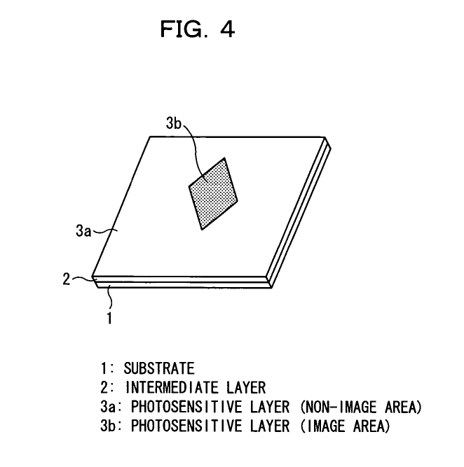

When an image shown in FIG. 4 is formed, hydrophobic ink deposited on the hatched portion (i.e., the hydrophobic image area) 3b and fountain solution preferentially adheres to the remaining white background portion (i.e., hydrophilic non-image area) 3a on which the hydrophobic ink is repelled to be hardly deposited. The emergence of an image (a pattern) allows the photosensitive layer 3 to function as a printing plate that is ready for printing. After that, a normal printing process takes place and is accomplished.

Subsequently, a manner of regenerating a printing plate will be described.

Hereinafter, “regeneration of the printing plate” represents a conversion of a property of the photocatalyst from hydrophilic to hydrophobic to restore the printing plate to the initial state in making a printing plate ready for printing by evenly hydrophilizing the entire surface of the printing plate, at least part of which is exhibiting hydrophobic while the remaining part of which is exhibiting hydrophilic, and successively by irradiating the surface of the printing plate 5 with energy flux of one of or an arbitrary combination of light, electricity heat and the like, by applying mechanical stimulus such as friction to the surface of the printing plate 5, or by applying an organic compound to the surface of the printing plate 5 so that the organic compound and the photosensitive layer 3 interacts. The step of evenly hydrophilizing the entire surface of the printing plate 5 prior to the hydrophobizing step is performed in order to completely delete the image area formed on the printing plate and should by no means be performed each time. The printing plate can be practically regenerated without carrying out the hydrophilization step.

At the beginning, an ink removal step (S230) is performed so that ink, fountain solution, paper dust and the like remaining on the surface of the photosensitive layer 3 after printing are removed. The ink removal is performed by one of moving ink to paper while a print press is operating without supplying the printing plate with ink; wiping off ink with a reeled cleaning cloth tape; wiping off the ink with a mechanism of a roller around which cloth is wrapped; and by spraying a solvent having an effect on washing off ink onto the surface of the printing plate wash off ink.

After that, as shown in the step (e), the entire surface of the photosensitive layer 3 is irradiated with the activating light at the hydrophilization step (S240), so that the image area 3b becomes also hydrophilic. That makes the entire surface of the photosensitive layer 3 come into a hydrophilic state, which has the contact angle of water 6 thereon up to 10°, that is, into a state shown in FIG. 2 and the image area can be completely deleted.

The property that a hydrophobic image area on the photosensitive layer 3 is converted into a surface with a high hydrophilic state by irradiation with the activating light can be realized by the use of, for example, a titanium oxide photocatalyst. In the illustrated example, a hydrophobic image area is converted into a hydrophilic state by an ultraviolet lamp as shown at step (e) of FIG. 3 whereupon the entire surface of the photosensitive layer 3 comes into a hydrophilic state and the image area is completely deleted.

In the ensuing hydrophobization step (S200), the surface of the printing plate 5 is irradiated with energy flux of one or an arbitrary combination of light, electricity, heat and the like, applied mechanical stimulus such as friction to the surface of the printing plate 5, or applied an organic compound to the surface of the printing plate 5 so that the organic compound interacts with the photosensitive layer 3. Thereby, a property of the photocatalyst is converted from hydrophilic to hydrophobic, thereby restoring to the initial state in making the printing plate ready for printing.

The hydrophilization step (S240) is included in the procedural steps in order to completely delete an image area. However, if the ink removal step (S230) removes ink adhered to the plate surface to an extent that the remaining ink does not affect on an ensuring printing process, the procedural steps may skip the hydrophilization step (S240) and the ink removal step (S230) may be directly followed by the hydrophobization step (S200).

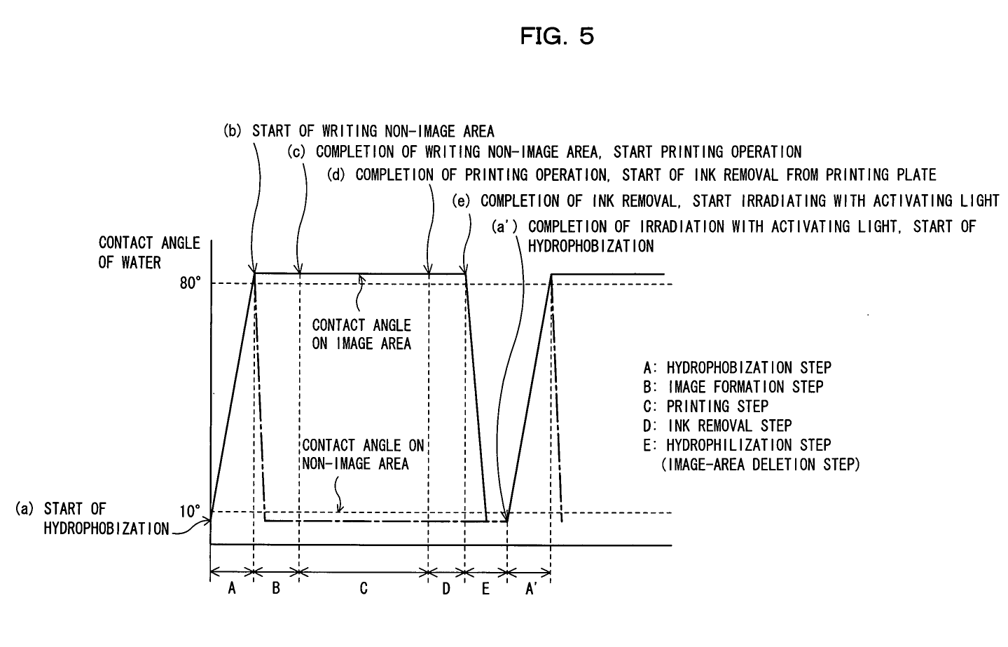

The above description is summarized in graph FIG. 5. Plots in abscissa represent time (or the procedural steps); and plots in ordinate represent the contact angle of water 6 on the surface of printing plate 5. The graph indicates a change of the contact angle of water 6 on the surface of the printing plate 5 of this embodiment in accordance with the passage of time and performance of the procedural steps. The one-dotted line in the graph represents the contact angle of water on the non-image area 3a of the photosenstive layer 3; and the solid line, that on the image area 3b.

First of all, the surface of the photosensitive layer 3 is irradiated with the activating light, so that the surface of the photosensitive layer 3 is in a high hydrophilic state having a contact angle of water 6 thereon is up to 10°.

In the hydrophobization step (S200) (step A in FIG. 5), a photocatalyst property is converted from hydrophilic to hydrophobic by irradiating the photosensitive layer 3 with energy flux of one of or an arbitrary combination of light, electricity, heat and the like, by applying mechanical stimulus, such as friction, to the surface of the printing plate 5, or by applying an organic compound to the surface of the printing plate 5 so that the organic compound interacts with the photosensitive layer 3. At that time, a preferable contact angle of water 6 is equal to or larger than 50°, more preferably equal to or larger than 80°. Upon completion of the hydrophobization (time point (b) in FIG. 5), the printing plate 5 is in the “initial state” in making the printing plate ready for printing.

The ensuing image formation step (S210) (step B in FIG. 5) starts writing a non-image area on the surface of the photosensitive layer 3 in a hydrophobic state using the activating light (time point (b) in FIG. 5). The portion of the photosensitive layer 3, which portion has been irradiated with the activating light, is converted from hydrophobic to hydrophilic by the action of the photocatalyst. Namely, the irradiated portion has a contact angle of water 6 thereon up to 10°. Conversely, the portion of the photosensitive layer 3, which portion has not been irradiated with the activating light, maintains hydrophobicity whereupon the non-irradiated portion with the activating light of the photosensitive layer 3 becomes an image area in a hydrophobic state and the irradiated portion with the activating light thereof becomes a non-image area in a hydrophilic state. Thereby the photosensitive layer 3 functions as a printing plate ready for printing.

After completion of writing of a non-image area, printing operation started (time point (C) in FIG. 5) to carry out the printing step (S220) (step C in FIG. 5).

After completion of the printing operation, the ink removal step (S230) (step D in FIG. 5) removes ink, dust or the like remaining on the surface of the photosensitive layer 3 (time point (d) in FIG. 5).

In the next hydrophilization step (S240)(step E in FIG. 5) performed after ink removal, irradiation of the surface of the photosensitive layer 3 with the activating light is started (time point (e) in FIG. 5). The irradiation converts a hydrophobic image area to a hydrophilic non-image area because of the action of the photocatalyst. As a consequence, the entire surface of the photosensitive layer 3 restores to hydrophilicity again.

After that, the printing plate restores to the “initial state” in making the printing plate ready for printing by performing the successive hydrophobization step (S200) (step A′ in FIG. 5) in which energy flux of one of or an arbitrary combination of light, electricity, heat and the like is irradiated the surface of the printing plate 5, mechanical stimulus, such as friction, is applied to the surface of the printing plate 5, or an organic compound is applied to the surface of the printing plate 5 so that the organic compound interacts with the photosensitive layer 3 (time point a′ in FIG. 5). The printing plate in question is ready for being reused.

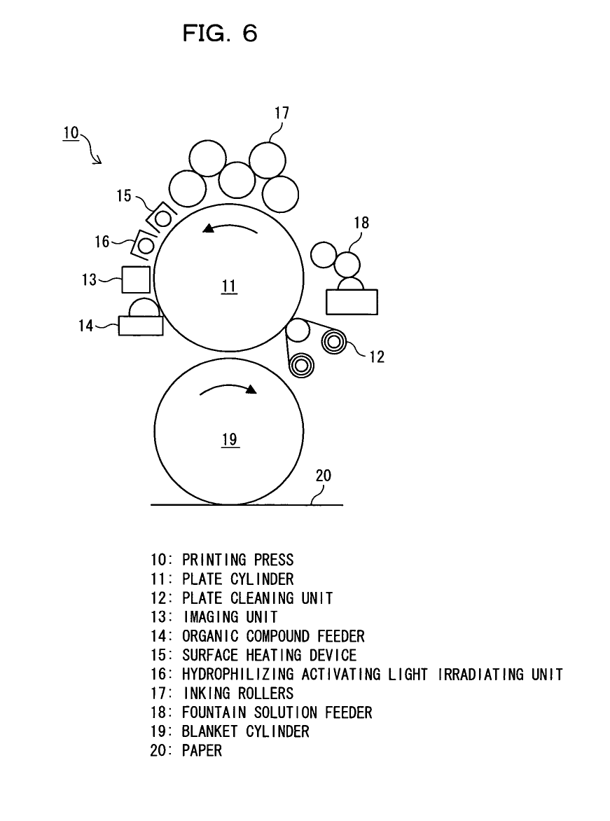

The above printing and regenerating of a printing plate are preferably performed in print system (printing press) 10 shown in FIG. 6. The printing press 10 comprises a plate cylinder 11 disposed in the center thereof, and additionally includes a plate cleaning unit 12, an imaging unit 13, an organic compound feeder 14 serving as a hydrophobization unit, a surface heating device 15, a hydrophilizing activating light irradiating unit 16 functions as an image-area deleting unit, inking rollers 17, a fountain solution feeder 18, and a blanket cylinder 19, which are disposed around the plate cylinder 11. Printing plate 5 is wrapped around the plate cylinder 11.

Methods of fabricating and regenerating a printing plate will now be described with reference to FIG. 6. As described above, the regeneration step of a printing plate, which is wrapped around the plate cylinder 11, is performed as follows after completion of a printing step.

The plate cleaning unit 12 in contact with the plate cylinder 11 wipes off ink, the fountain solution and paper dust remaining on the surface of printing plate 5. Plate cleaning unit 12 of FIG. 6 has a mechanism of reeling ink cleaning cloth tape, but should by no means be limited to the above example, of course.

After that, the plate cleaning unit 12 is disengaged from the plate cylinder 11 and the hydrophilizing activating light irradiating unit 16 irradiates the entire surface of the printing plate with the activating light to hydrophilize the plate surface. In this event, it is possible to use light having a wavelength equal to or shorter than that of visible light, i.e., light having a wavelength up to 600 nm, as the activating light. During the hydrophilization, the plate surface may be irradiated with the activating light, concurrently being heated by the surface heating device 15.

Then the organic compound feeder 14 applies an organic compound to the plate surface to cause the organic compound to interact with the photosensitive layer 3, so that the surface of the printing plate 5 is hydrophobized. The organic compound feeder 14 in FIG. 6 takes the form of a roller applier but should by no means be limited to such an applier. The hydrophobization unit is described as a feeder to apply an organic compound to the surface of the printing plate 5. Alternatively, the hydrophobization unit may irradiate the surface of the printing plate 5 with energy flux of one of or an arbitrary combination of light, electricity, heat and the like, or apply mechanical stimulus, such as friction, to the surface of the printing plate 5. In order to enhance the interaction between the organic compound and the plate surface, the surface of the printing plate 5, to which the organic compound has been applied, may be heated by the surface heating device 15.

Next, the imaging unit 13 irradiates with the activating light based on digital image data previously prepared so that a non-image area is written (that is, the image is formed on the plate surface).

After image formation, the inking rollers 17, the fountain solution feeder 18 and the blanket cylinder 19 are come to contact with the plate cylinder, and paper 20 comes to contact with the blanket cylinder 19. In this arrangement, rotation in the directions that the arrows in FIG. 6 indicate sequentially applies fountain solution and ink to the surface of the printing plate and printing is carried out.

It is possible for the printing press 10 to undergo the series of steps from regenerating of the printing plate to making the printing plate ready for printing—cleaning the plate surface after printing; deleting an image area by irradiation with the activating light; applying an organic compound to the plate surface; and forming an image—while the printing plate 5 is mounted on the plate cylinder 11 of the printing press 10. This enables the printing press 10 to perform continuous printing process without halting the operations and also without being interrupted by replacement of a printing plate.

As the structure of the printing press 10, the printing plate 5 is wrapped around the plate cylinder 11, but the structure should by no means be limited to this. Alternatively, a photosensitive layer including a photocatalyst may be formed directly on the plate cylinder 11, that is, the plate cylinder 11 and the printing plate is formed into one unit.

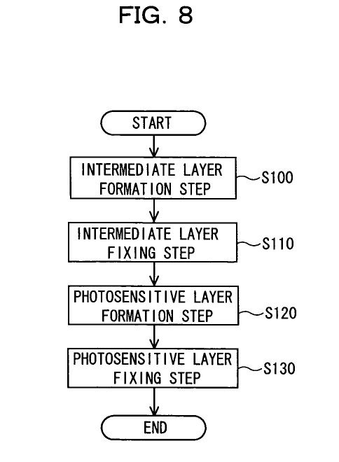

Hereinafter, a description is made in relation to fabrication and regeneration of a printing plate with reference to the results of experiment and observation by the Inventors. As shown in flowchart FIG. 8, a succession of procedural steps of fabricating the printing plate 5 includes an intermediate layer formation step (S100), an intermediate layer fixing step (S110), a photosensitive layer formation step (S120) and a photosensitive layer fixing step (S130).

(a) Description of Photocatalyst:

<Preparation of Catalyst>

The Ammonia solution was added to a starting material of a titanium sulfate (a product of Wako Pure Chemical Industries, Ltd.) while stirring the mixture to obtain a titanium sulfate hydrolysate, which was filtered through a Buchner funnel. The residue titanium sulfate hydrolysate was washed with deionized water until electrical conductivity of the filtrate came to be 2 μS/cm or lower. After washing, the hydrolysate was dried at room temperature and then burned in the atmosphere for two hours at 400° C. The burned product was roughly milled with a mortar, and a powder-form photocatalyst was obtained.

<Confirmation of Visible-Light Activity>

The above powder-form photocatalyst (0.2 g) was evenly spread over the bottom of a sealable cylindrical reaction container (500 ml) made of Pyrex® glass. The atmosphere in the reaction container was deaerated and substituted with highly-purified air. Acetone (500 ppm) was added into the reaction container and was absorbed into the photocatalyst in a dark place for 10 hours at 25° C. until the contents in the reaction container reached absorption equilibrium. After that, the contents were irradiated with light (having the major wavelength of 470 nm) emitted from blue LED (produced by Nichia Corporation). As a result of a follow-up measurement on amounts of acetone and carbon dioxide (CO₂) using a gas chromatograph manufactured by Shimazu Corporation, the Inventors confirmed that irradiation with light emitted from the blue LED for 25 hours decomposed all acetone in the reacting container and generated carbon dioxide CO₂ the amount of which corresponds to the stoichiometry proportion of the acetone. Namely, the Inventors have confirmed that the photocatalyst exhibited catalytic activity by light having a wavelength of 470 nm.

### (b) EXAMPLE 1

<Preparation of Printing Plate>

Tungstic acid (2.155 g, a product of Wako Pure Chemical Industries, Ltd.) is added into oxygenate (H₂O₂₃₅%, 18g) and the mixture is stirred in a water bath at 65° C. to dissolve tungstic acid. After cooling the mixture to room temperature, ammonia water (ammonia concentration 28%, 2.1 g) is added to the mixture and is stirred and water-cooled. After that, the mixture is heated in a water bath at 65° C., and is stirred until no bubble is produced. The mixture was diluted with deionized water until the total volume becomes 40 g and the resultant solution is regarded as a semiconductor applier solution X.

The above powder-form photocatalyst was dispersed in deionized water to obtain slurry (solid content 20 wt %), which was milled in a wet mill (product name: dyno mill PILOT) and was used as a photocatalytic dispersed solution.

Alkaline degreasing was performed on a stainless-steel (SUS301) substrate 1 having an area of 280×204 mm and a thickness of 0.1 mm to prepare substrate for a printing plate.

As shown in FIG. 8, the semiconductor applier solution X was dip-coated on the above substrate in the intermediate layer formation step (S100). In the ensuing intermediate layer fixing step (S110), the semiconductor applier solution X was air-dried and then heated for 30 minutes at 500° C. to be fixed on the substrate and thereby an intermediate layer 2 was formed. The formed intermediate layer 2 has a thickness of approximately-0.07 μm and a composition of a tungsten oxide WO₃, which composition was appreciated as the result of an analysis.

The substrate, on which the intermediate layer 2 has formed, was dip-coated with the mixture of the photocatalytic dispersed solution and TKC-301, product of Tayca Corporation, at a weight ratio of 1:8 in the photocatalyst layer forming step (S120), and was then heated at 350° C. in the photocatalyst layer fixing step (S130) to form the photocatalyst layer (photosensitive layer) 3 on the surface of substrate 1, which was to serve as a printing plate 5. The photosensitive layer 3 had a thickness of approximately 0.1 μm. As a result of measurement with contact angle meter, Model CA-W, manufactured by KYOWA INTERFACE SCIENCE CO., LTD., the surface of printing plate obtained a contact angle of 80 in relation to water thereon, which angle is enough to exhibit hydrophilicity.

<Preparation of Printing>

Ttitanium-1-propoxyoctylene glycol (2 g, product of Nippon Soda Co., Ltd.) was dissolved in a paraffin solution (98 g, product name Isopar®-L manufactured by Exxon Mobile Corporation), and the resultant solution was used as hydrophobizing solution Y.

The above printing plate showing hydrophilicity was installed on a desk-top offset printing press (New Ace Pro, trademark; manufactured by ALPHA ENGINEERING INC.), and the hydrophobizing solution Y was sprayed over the surface of printing plate, which was dried by a hot-air dryer. After that, printing plate was temporarily displaced from the printing press to measure a contact angle against water 6 using the contact angle meter. The measured contact angle was 75°, which exhibits adequate hydrophobicity, so that printing plate 5 was confirmed to be in the initial state in the making of the printing plate.

<Image Formation>

Subsequently, halftone dot images of halftone-dot-area percentages ranging from 10% to 100% were formed onto the surface of the printing plate at 10% intervals by an imaging system utilizing semiconductor laser beams having a wavelength of 405 nm, an output of 5 mW per channel and a beam diameter of 15 μm. The measurement of contact angles using the contact angle meter confirmed that contact angles on portions written and not written by the semiconductor laser beams were respectively 8° and 75° so that the written and not-written portions were respectively a hydrophilic non-image area and a hydrophobic image area.

<Printing>

The printing plate was mounted on the New Ace Pro desk-top offset printing press, and the formed image was printed on sheets of paper (ibest paper) using an ink HYECOO B Crimson MZ (trade name; product of Toyo Ink Mfg. Co., Ltd.) and the fountain solution, a 1% solution of LITHOFELLOW (trade mark; product of Mitsubishi Heavy Industries, Ltd.) at a printing speed of 3,500 sheets/hour. The halftone dot images were successfully printed on the first paper sheet.

<Regeneration>

Next, an example of regeneration of the printing plate will be now described. After completion of printing, the entire surface, from which ink, fountain solution, paper dust and the like had been removed, was irradiated with ultraviolet light having a wavelength of 254 nm and an illuminance of 10 mW/cm² emitted from a low-pressure Mercury lamp for 20 seconds. Immediately after that, the contact angle of water on a portion on which the half-tone dot image had been formed was measured with the result that the contact angle of water 6 was 8°, which would provide sufficient hydrophilicity. It was confirmed that the image area had been completely deleted.

The hydrophobizing solution Y was sprayed over the surface of the printing plate and was dried by a hot-air dryer. The contact angle of water 6 was measured with the above contact angle meter and the measured contact angle was 73°, which was exhibiting enough hydrophobicity. The printing plate was confirmed to be restored to the initial state in making the printing plate ready for printing and to be regenerated.

### (c) COMPARATIVE EXAMPLE 1

<Preparation of Printing Plate>

In order to prepare the substrate 1, alkaline degreasing was performed on a stainless-steel (SUS301) board having an area 280×204 mm and a thickness 0.1 mm while dip-coating using the semiconductor applier solution X was not performed on the same board. Except the preparation of the substrate 1, a photosensitive layer 3 was formed on the plate substrate in the same manner as Example 1 and the printing plate 5 was fabricated. The formed photosensitive layer 3 has a thickness of approximately 0.1 μm. The contact angle of water 6 on the surface of the printing plate 5 is measured with the “Contact Angle Meter, Model CA-W” (trade name; manufactured by KYOWA INTERFACE SCIENCE CO., LTD.) with the result that the measured contact angle was 7°, which angle is enough to exhibit hydrophilicity.

<Preparation of Printing>

Hydrophobization is performed on the printing plate 5 in the same manner as Example 1. The contact angle of water 6 is measured using the contact angle meter, and the measured contact angle was 74°, which angle is enough to exhibit hydrophobicity.

<Image Formation>

Subsequently, halftone dot images of halftone-dot-area percentages ranging from 10% to 100% were written onto the surface of printing plate 5 at 10% intervals by an imaging system utilizing semiconductor laser beams having a wavelength of 405 nm, an output of 5 mW per channel and a beam diameter of 15 μm. The measurement of a contact angle after the image formation using the contact angle meter confirmed that contact angle on portion written by the semiconductor laser beams were 23° that did not exhibit adequate hydrophilicity. Namely, the printing plate 5 of the comparative example 1 was confirmed to have at least one of lower catalytic activity to oxidative decompose an organic compound and lower catalytic activity to hydrophilize the photocatalyst than the printing plate 5 of the example 1 having the intermediate layer 2 made of a tungsten oxide WO₃. The portion not written had a contact angle of 75° and therefore maintained hydrophobicity.

<Performing of Printing>

The printing was performed at the speed of 3,500 sheets/hour in the same manner as that performed for the example 1. A non-image area, on which ink should not be fundamentally attached, was lightly coated with ink and the printing result was contaminated. It is assumed that ink attachment to the non-image area was caused by inadequate decline of a contact angle on the non-image area so that the non-image area did not provide sufficient hydrophilicity and some ink was attached to the non-image area.

<Regeneration>

After completion of printing, the entire surface, from which ink, fountain solution, paper dust and the like had been removed, was irradiated with ultraviolet light, having a wavelength 254 nm and an illuminance of 10 mW/cm², emitted from a low-pressure Mercury lamp for 20 seconds. Immediately after that, the contact angle of water 6 on a portion on which the half-tone dot image had been formed was measured with the result that the contact angle of water was 25°, which was not sufficiently hydrophilized so that the image area could not be completely deleted.

### (d) EXAMPLE 2

<Preparation of Printing Plate>

Fine particles (particle diameter approx. 500 nm) of a tin oxide (SnO) was mixed with SiO₂ sol (trade name SNOWTEX, product of NISSAN CHEMICAL INDUSTRIES, LTD.) at a solid SnO/SiO₂ ratio of 6/4 and thereby a semiconductor applier solution X′ is obtained.

The above powder-form photocatalyst was dispersed in deionized water to obtain slurry (solid content 20 wt %), which was milled in a wet mill (product name: dyno mill PILOT) and was used as a photocatalytic dispersed solution.

Alkaline degreasing was performed on a stainless-steel (SUS301) substrate 1 the area of which was 280×204 mm and the thickness of which was 0.1 mm to prepare substrate for a printing plate.

The semiconductor applier solution X′ was dip-coated on the above substrate in the intermediate layer formation step (S100). In the ensuing intermediate layer fixing step (S110), the semiconductor applier solution X′ was air-dried and then heated for 30 minutes at 500° C. to be fixed on the substrate. Thereby an intermediate layer 2 was formed. The formed intermediate layer 2 have a thickness of approximately 0.09 μm.

The substrate, on which the intermediate layer 2 has formed, was dip-coated with the mixture of the photocatalytic dispersed solution and TKC-301, product of Tayca Corporation, at a weight ratio of 1:8 in the photocatalyst layer forming step (S120), and was then heated at 350° C. in the photocatalyst layer fixing step (S130) to form the photocatalyst layer (photosensitive layer) 3 on the surface of the intermediate layer 2, so that the substrate 1 was to serve as a printing plate 5. The photosensitive layer 3 had a thickness of approximately 0.1 μm. As a result of measurement with the contact angle meter, Model CA-W, manufactured by KYOWA INTERFACE SCIENCE CO., LTD., the surface of printing plate obtained a contact angle of 80 in relation to water thereon, which angle is enough to exhibit hydrophilicity.

<Preparation of Printing>

1,2-epoxyhexadecane (0.3 g, a product of Wako Pure Chemical Industries, Ltd.) was dissolved in a paraffin solution (99.7 g, product name Isopar®-L manufactured by Exxon Mobile Corporation), and the resultant solution was used as hydrophobizing solution Y′.

The above printing plate showing hydrophilicity was installed on a desk-top offset printing press (New Ace Pro, trademark; manufactured by ALPHA ENGINEERING INC.), and the hydrophobizing solution Y′ was evaporated and sprayed, using a nebulizer, over the surface of printing plate, which was dried by a hot-air dryer. After that, printing plate was temporarily displaced from the printing press to measure a contact angle against water 6 using the contact angle meter. The measured contact angle was 85°, which exhibits adequate hydrophobicity.

<Image Formation>

Subsequently, halftone dot images of halftone-dot-area percentages ranging from 10% to 100% were formed onto the surface of the printing plate at 10% intervals by UV-setter™ 710 (wavelength 360-450 nm) manufactured by basysPrint GmbH. Image formation is carried out in a manner that images are concurrently formed on areas (mini-pictures), each of which is a square of 13 mm by 17 mm, at a speed of 10 mini-pictures per second. The measurement of contact angles using the contact angle meter confirmed that contact angles on portions written and not written by the ultraviolet light beams were respectively 80 and 850 so that the written and not-written portions were confirmed to be a hydrophilic non-image area and a hydrophobic image area, respectively.

<Printing>

A printing operation was performed in the same manner as Example 1 and the halftone dot images were successfully printed on the first paper sheet.

<Regeneration>

After completion, ink removal and hydrophilization by irradiation with ultraviolet light were performed in the same manner as the Example 1. The contact angle of water 6 on the plate surface, which has been hydrophilized, was measured with the result of a contact angle 8°.

The hydrophobizing solution Y′ was then evaporated by nebulizer, applied to the plate surface, and dried using a hot-air drier. The contact angle meter measured the contact angle of water 6 on the plate surface and the measured contact angle was 86°, so that the printing plate 5 has been restored to the “initial state” in making the printing plate ready for printing.

### (e) COMPARATIVE EXAMPLE 2

<preparation of Printing Plate>

In order to prepare the substrate 1, alkaline degreasing was performed on a stainless-steel (SUS301) board having an area of 280×204 mm and a thickness of 0.1 mm while dip-coating using the semiconductor applier solution X′ was not performed on the same board. Except the preparation of the substrate 1, a photosensitive layer 3 was formed on the plate substrate in the same manner as Example 2 and the printing plate 5 was fabricated. The formed photosensitive layer 3 has a thickness of approximately 0.1 μm. The contact angle of water 6 on the surface of the printing plate 5 is measured with the “Contact Angle Meter, Model CA-W” (trade name; manufactured by KYOWA INTERFACE SCIENCE CO., LTD.) with the result that the measured contact angle was 7°, which angle is enough to exhibit hydrophilicity.

<Preparation of Printing>

The printing plate 5 was hydrophobized in the same manner as Example 2. The contact angle of water 6 is measured using the contact angle meter, and the measured contact angle was 86°, which angle is enough to exhibit hydrophobicity.

<Image Formation>

In the same manner as Example 2, halftone dot images were formed at the speed of 10 mini-pictures per second. The contact angle of water 6 on the surface of printing plate, on which the images have been formed, was measured with the contact angle meter. The contact angle on the portion written with ultraviolet light beam was 26°, which angle was inadequate hydrophilicity. The portion not written had a contact angle of 85° and maintained hydrophobicity.

<Performing of Printing>

The printing was performed at the speed of 3,500 sheets/hour in the same manner as the Example 2. A non-image area, on which ink should not be fundamentally deposited, was lightly coated with ink and the printing result was contaminated.

<Regeneration>

After completion of printing, the entire surface, from which ink, fountain solution, paper dust and the like had been removed, was irradiated with ultraviolet light, having a wavelength 254 nm and an illuminance of 10 mW/cm², emitted from a low-pressure Mercury lamp for 20 seconds. Immediately after that, the contact angle of water 6 on a portion on which the half-tone dot image had been formed was measured with the result that the contact angle of water was 26°, which would not provide sufficient hydrophilicity so that the image area could not be completely deleted.

As reveled by the foregoing examples, the printing plate 5 according to an embodiment can be reused and additionally the regeneration cycle can be rapidly accomplished. In other words, formation of a layer including a semiconductor or an electric conductor, i.e., an intermediate layer 2, between a substrate 1 and a photosensitive layer 3 enhances the catalytic activity of the photocatalyst. That realizes fabrication and regeneration of a printing plate in a short time. As a result, the entire printing process can be accomplished extremely rapidly.

Achievement of regeneration and reuse of a printing plate can greatly reduce the amount of printing plate wastes discarded after printing. Further, an image area is not formed by a polymer, there is no requirement for washing solvent to wash of the polymer when a printing plate is to be regenerated. In addition to such a ecological aspect, it is possible to remarkably reduce the costs for a printing plate 5.

Since it is possible to form an image on a printing plate 5 directly from digital image data, digitized printing process is realized so that corresponding time and costs for printing can be vastly reduced.

The above description was regarding an embodiment of the present invention, but the present invention should by no means be limited to the described embodiment. Various change and modification is suggested without departing from the gist of the present invention.

For example, if an intermediate layer 2 is fixed to a substrate 1 without being dried or burnt after formation of the intermediate layer 2 on the substrate 1 in this embodiment, the procedural steps may skip the intermediate layer fixing step and jump to a photosensitive layer formation step to form a photosensitive layer 3. In other words, a photosensitive layer 3 may be formed after formation of an intermediate layer 2 on a substrate 1, and then the intermediate layer 2 and the photosensitive layer 3 may be concurrently fixed on the substrate 1 by heating or burning.

What is claimed is:

1. A printing plate, on which an image is formed by light having a wavelength equal to or shorter than that of visible light and which is able to be made ready for printing without a wet development process and to be regenerated for reuse, comprising:
a substrate (1);
a photosensitive layer (3), formed on a surface of said substrate (1) and including a photocatalyst that responds to light having a wavelength equal to or shorter than that of visible light because of setting a new level in a band gap of a titanium oxide photocatalyst; and
an intermediate layer (2), interposed between said substrate (1) and said photosensitive layer (3) and including a semiconductor or an electric conductor.

2. A printing plate according to claim 1, wherein said substrate (1) has flexibility.

3. A printing plate according to claim 1 or 2, wherein said intermediate layer (2) includes tungsten oxide serving as a semiconductor.

4. A printing plate according to one of claims 1-3, wherein, when the image is to be formed on said printing plate, a property of a surface of said photosensitive layer (3) is converted from hydrophobic to hydrophilic by irradiation with the light having a wavelength equal to or shorter than that of visible light.

5. A printing plate according to one of claims 1-4, wherein, when said printing plate is to be regenerated, a property of the surface of said photosensitive layer (3) is converted from hydrophilic to hydrophobic by irradiating a surface of said printing plate with energy flux, such as light, electricity and/or heat, or by applying a mechanical stimulus, such as friction, to the surface of said printing plate.

6. A printing plate according to one of claims 1-4, wherein, if an organic compound is applied to the surface of said photosensitive layer (3) in order to regenerate said printing plate, the organic compound interacts with said photosensitive layer (3) so that a property of the surface of said photosensitive layer (3) is converted from hydrophilic to hydrophobic.

7. A printing plate according to one of claims 1-6, wherein the photocatalyst is a titanium oxide photocatalyst or a modified titanium oxide photocatalyst.

8. A printing plate according to one of claims 1-7, wherein the light having wavelength equal to or shorter than that of visible light has a wavelength equal to or shorter than 600 nm.

9. (amended) A method for fabricating a printing plate, on which an image is formed by light having a wavelength equal to or shorter than that of visible light and which is able to be made ready for printing without a wet development process and to be regenerated for reuse, comprising the steps of:
forming an intermediate layer (2), including a semiconductor or an electric conductor, on a surface of a substrate (1);
fixing the intermediate layer (2) on the surface of the substrate (1);
forming a photosensitive layer (3), including a photocatalyst that responds to light having a wavelength equal to or shorter than that of visible light because of setting a new level in a band gap of a titanium oxide photocatalyst, on a surface of the intermediate layer (2); and
fixing the photosensitive layer (3) on the surface of the intermediate layer (2).

10. A method for fabricating a printing plate, on which an image is formed by light having a wavelength equal to or shorter than that of visible light and which is able to be made ready for printing without a wet development process and to be regenerated for reuse, comprising the steps of:
forming an intermediate layer (2), including a semiconductor or an electric conductor, on a surface of a substrate (1);
forming a photosensitive layer (3), including a photocatalyst that responds to light having a wavelength equal to or shorter than that of visible light because of setting a new level in a band gap of a titanium oxide photocatalyst, on a surface of the intermediate layer (2); and
fixing the photosensitive layer (3) and the intermediate layer (2) on the surface of the surface of the substrate (1).

11. A method for regenerating a printing plate defined in one of claims 1-8, comprising the steps of:
after completion of a printing operation,
removing an ink from a surface of the printing plate; and
hydrophobizing a surface of the photosensitive layer (3).

12. A method for regenerating a printing plate according to claim 11, further comprising the step of:
between said step of ink removing and said step of hydrophobizing,
irradiating the surface of the photosensitive layer (3) with light having a wavelength equal to or shorter than that of visible light so that the surface of the photosensitive layer (3) is hydrophilized.

13. A method for regenerating a printing plate according to claim 11 or 12, wherein said step of hydrophobizing includes one of steps of irradiating the surface of the photosensitive layer (3) with energy flux, such as light, electricity and/or heat, applying a mechanical stimulus, such as friction, to the surface of the photosensitive layer (3), and applying an organic compound to the surface of the photosensitive layer (3) so that the organic compound interacts with the surface of the photosensitive layer (3).

14. A printing press comprising:
a plate cylinder having a curved surface for supporting a printing plate defined in one of claims 1-8;
an image forming unit for irradiating a surface of the photosensitive layer (3) with the light having a wavelength equal to or shorter than that of visible light; and
a hydrophobizing unit for hydrophobizing the surface of the photosensitive layer (3).

15. A printing press according to claim 14, wherein said hydrophobizing unit hydrophobizes the surface of the photosensitive layer (3) by one of irradiating the surface of the photosensitive layer (3) with energy flux, such as light, electricity and/or heat, applying a mechanical stimulus, such as friction, to the surface of the photosensitive layer (3), and applying an organic compound to the surface of the photosensitive layer (3) so that the organic compound interacts with the surface of the photosensitive layer (3).

16. A printing press according to claim 14 or 15, further comprising an image area deleting unit for irradiating the entire surface of the printing plate with light having a wavelength equal to or shorter than that of visible light in order to delete an image area.
